(19) United States
(12) Patent Application Publication
(10) Pub. No.: US 2004/0164208 A1
(43) Pub. Date: Aug. 26, 2004

(54) Method and apparatus for supporting cables

(76) Inventors: Erik R. Nielson, Houston, TX (US); Kelly K. Smith, Houston, TX (US); Karl J. Dobler, Cypress, TX (US); Daniel T. Thompson, Houston, TX (US); Kevin D. Conn, Magnolia, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/371,915

(22) Filed: Feb. 21, 2003

(51) Int. Cl. F16L 3/00

(52) U.S. Cl. 248/49

(57) ABSTRACT

A method and apparatus for supporting cables. In some embodiments, the cable support system comprises a first member and a movable pin. The first member may be secured to a cable support arm. The first member also may be adapted to be disposed against a second member. The second member may be secured to a movable device or a fixed member. The first member may be adapted to prevent transverse displacement of the first and second members when the first member is displaced laterally to a first position relative to the second member. The movable pin may be adapted to block lateral displacement of the first and second members, when the first member is displaced in the first position relative to the second member.

### BACKGROUND OF THE INVENTION

This section is intended to introduce the reader to various aspects of art, related to the present subject matter described and/or claimed below. The discussion is believed to be helpful in providing the reader with background information to facilitate a better understanding of various aspects of the present subject matter. Accordingly, it should be understood that these statements are to be read in this light, and not as admissions of prior art.

Cables are commonly used to transmit power and/or data to and from electrical devices or systems. In fact, some electronic devices have many cables connected to them. In addition, some electronic systems utilize several electronic devices and have several cables routed between the devices. Sometimes, the devices are mounted within a vertical storage rack. For example, servers and/or other devices may be mounted within at least one rack. In addition, the storage rack and the electronic devices may be designed to enable the electronic devices to be withdrawn, at least partially, from the storage rack to provide access to the interior of the device.

Maintaining control of all of the cables that may be deployed in an electronic system is important to prevent damage to the cables and to prevent the cables from becoming entangled. Consequently, a cable management system may be utilized to support one or more of the cables connected to an electronic device.

However, there are a number of problems associated with existing cable management systems. For example, cable management systems may be difficult and time consuming to install. Consequently, some customers do not install the cable management systems provided. As a result, the cables may become entangled or damaged.

### BRIEF DESCRIPTION OF THE DRAWINGS

Embodiments of the invention will hereafter be described with reference to the accompanying drawings, wherein like reference numerals denote like elements, and:

FIG. 1 is an elevational view of an electronic system in accordance with an embodiment of the present invention;

FIGS. 2 and 3 are perspective views illustrating part of an embodiment of an electronic system in accordance with an embodiment of the present invention;

FIG. 4 is a perspective view of a portion of the electronic system illustrated in FIG. 2;

FIG. 5 is a perspective view of a portion of the electronic system illustrated in FIG. 2; and

FIGS. 6-8 are cross-sectional views taken generally along line 6-6 of FIG. 5 illustrating the securing of a cable support arm bracket to a bracket secured to the storage rack.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As discussed in detail below, the illustrated embodiment provides a system and method for supporting one or more cables or cords between a storage rack and at least one movable rack-mounted device. However, the present technique may be used to mount one or more cables or cords between a variety of components in a movable relationship. Moreover, a variety of movable carrier mechanisms, swappable mounts, and attachment mechanisms may be used within the scope of the present embodiment.

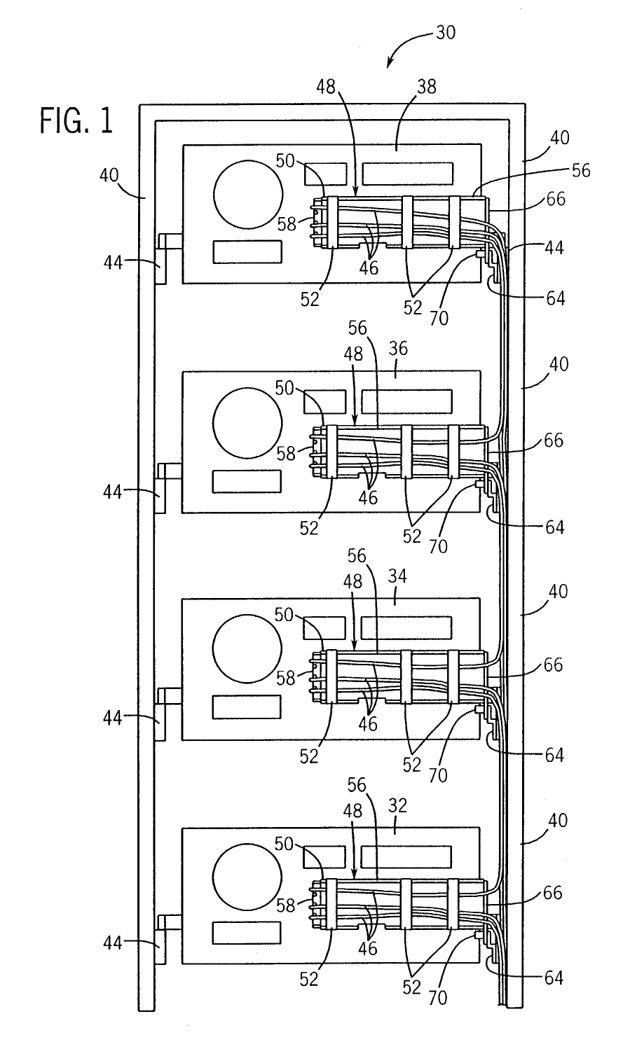

Referring generally to FIG. 1, an electronic system, generally designated by the reference numeral 30, is illustrated. In the illustrated embodiment, system 30 comprises electronic devices 32, 34, 36, and 38 housed within a storage rack 40. However, system 30 may comprise a greater or fewer number of electronic devices. Devices 32, 34, 36, and 38 may be any of a variety of electronic devices, such as a server, hard drive, etc. In addition, storage rack 40 may be any of a variety of different storage devices adapted to receive a greater or fewer number of devices.

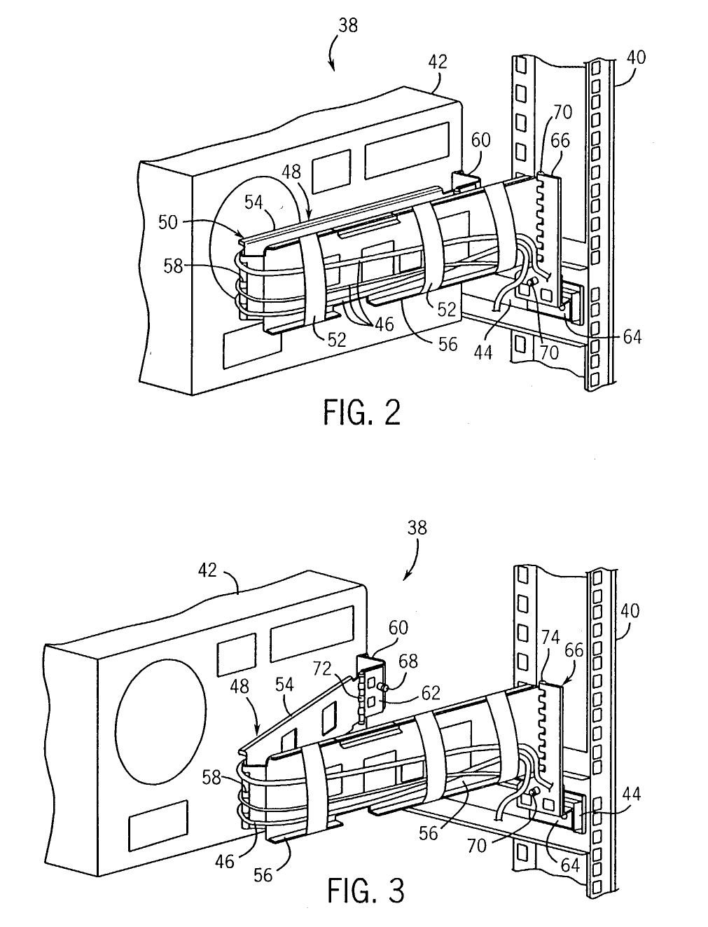

Referring generally to FIGS. 2 and 3, an embodiment of the present invention is illustrated. In the illustrated embodiment, electronic device 38 has a chassis 42. Electronic device 38 may be a server or any of a variety of different processor-based devices. However, a device other than a processor-based device may be used in other embodiments of the present invention. Electronic device 38 is movable along a slide 44 within storage rack 40. However, electronic device 38 may be movable along a different member, such as a rail.

In FIGS. 2 and 3, electronic device 38 is illustrated in different positions relative to storage rack 40. In FIG. 2, electronic device 38 is illustrated in a first position relative to storage rack 40. In FIG. 3, electronic device 38 is illustrated in a second position relative to storage rack 40. Electronic device 38 may have wheels or bearings to facilitate movement along slide 44. Also, a plurality of electric cables 46 may be connected to electronic device 38. Each cable 46 is connected at one end to electronic device 38. The other end of cables 46 may be connected to electronic devices 32, 34, and 36, or external devices or systems. However, cables 46 may be electrical cables, fiber optic cables, or other types of cables.

A cable management system 48 is employed to route cables 46 to electronic device 38. In the illustrated embodiment, cable management system 48 comprises an articulated cable support arm 50. In addition, cable management system 48 may comprise a plurality of securing straps 52 employed to secure cables 46 to cable support arm 50. In the illustrated embodiment, cable support arm 50 is secured to storage rack 40 and electronic device 38. Securing straps 52 and cable support arm 50 are adapted to support cables 46 so that the cables 46 are not dragged or entangled as electronic device 38 is moved relative to storage rack 40. Cable support arm 50 has a first arm 54 and a second arm 56 coupled by a hinge 58. Hinge 58 enables cable support arm 50 to articulate as electronic device 38 is moved relative to storage rack 40.

In the illustrated embodiment, one end of cable support arm 50 of cable management system 48 is secured to a chassis bracket 60 which, in turn, is secured to chassis 42 of electronic device 38. In addition, cable support arm 50 has an arm-to-chassis bracket 62 that is coupled to chassis bracket 60 to secure cable support arm 50 to electronic device 38 in this embodiment. However, electronic device 38 also may be adapted to enable arm-to-chassis bracket 62 to be secured directly thereto. In addition, arm-to-chassis bracket 62 is coupled to chassis bracket 60 without use of a tool or separate fastener.

In the illustrated embodiment, the other end of cable support arm 50 of cable management system 48 is secured to a slide bracket 64, which, in turn, is secured to slide 44. However, the other end of cable support arm 50 may be secured to a different portion of storage rack 40, if desired. Cable support arm 50 also comprises an arm-to-slide bracket 66 that is coupled to slide bracket 64 to secure cable support arm 50 to slide 44. Arm-to-slide bracket 66 is coupled to slide bracket 64 without use of a tool or a separate fastener.

Arm-to-chassis bracket 62 has a plunger pin 68 that locks arm-to-chassis bracket 62 to chassis bracket 60. Similarly, arm-to-slide bracket 66 comprises a plunger pin 70 to lock arm-to-slide bracket 66 to slide bracket 64. In the illustrated embodiment, plunger pins 68 and 70 are spring-biased and secured to arm-to-chassis bracket 62 and arm-to-slide bracket 66, respectively. In addition, arm-to-chassis bracket 62 and first arm 54 are adapted to form a hinge 72. Slide bracket 64 and second arm 56 also are adapted to form a hinge 74.

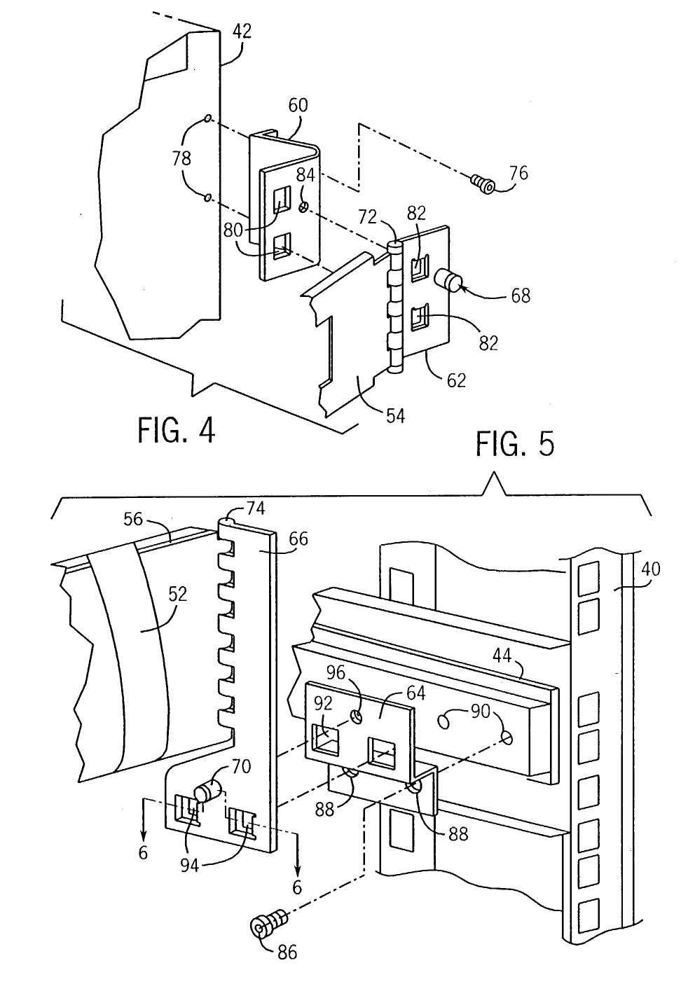

Referring generally to FIG. 4, chassis bracket 60 is secured to chassis 42 of electronic device 38 by a plurality of fasteners 76, such as rivets. Fasteners 76 are inserted through chassis bracket 60 into portions 78 of electronic device 38. In the illustrated embodiment, chassis bracket 60 has a pair of openings 80 extending therethrough. Each opening 80 is adapted to receive a corresponding hook 82 of arm-to-chassis bracket 62. Openings 80 and hooks 82 also may represent keyed slots and mushroom-shaped pins, respectively, and other methods of securement. Chassis bracket 60 has a hole 84 that is adapted to receive plunger pin 68.

In the illustrated embodiment, arm-to-chassis bracket 62 is secured to chassis bracket 60 by inserting each hook 82 through each opening 80 and then moving arm-to-chassis bracket 62 laterally downward, relative to chassis bracket 60, to cause each hook 82 to engage chassis bracket 60. Plunger pin 68 is employed to lock hooks 82 in an engaged position. Plunger pin 68 and hole 84 are adapted so that plunger pin 68 and hole 84 are not aligned when hook 82 is disposed through each opening 80. Consequently, plunger pin 68 is compressed as arm-to-chassis bracket 62 is disposed against chassis bracket 60. Hole 84 is oriented on chassis bracket 60 so that plunger pin 68 is brought into alignment with hole 84 when arm-to-chassis bracket 62 is lowered to hook chassis bracket 60. Plunger pin 68 extends outward into hole 84 when aligned with hole 84, locking arm-to-chassis bracket 62 to chassis bracket 60. Plunger pin 68 and hole 84 cooperate to prevent lateral movement of arm-to-chassis bracket 62 relative to chassis bracket 60. Hooks 82 prevent transverse movement of arm-to-chassis bracket 62 relative to chassis bracket 60.

Referring generally to FIG. 5, slide bracket 64 is secured to slide 44 by a plurality of fasteners 86. Fasteners 86 extend through holes 88 in slide bracket 64 and into threaded portions 90 of slide 44. Slide bracket 64 comprises two openings 92 adapted to receive corresponding hooks 94 of arm-to-slide bracket 66. Similarly, openings 92 and hook 94 also may represent keyed slots and mushroom-shaped pins, respectively, and other methods of securement. Slide bracket 64 also has a hole 96 adapted to receive plunger pin 70 when arm-to-slide bracket 66 is disposed laterally to the left, in this view. Please note that plunger pins 68 and 70 may be disposed on chassis bracket 60 and slide bracket 64, respectively, with corresponding holes 84 and 96 disposed on arm-to-chassis bracket 62 and arm-to-slide bracket 66, respectively.

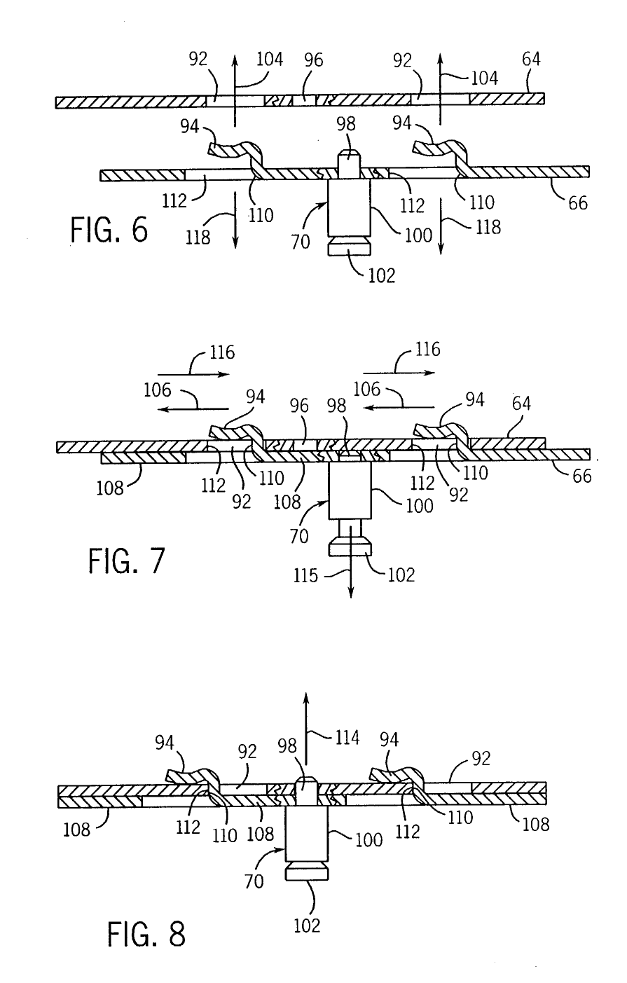

Referring generally to FIGS. 6-8, plunger pin 70 comprises a movable pin 98, a housing 100, and an operator 102. In this embodiment, movable pin 98 is biased outward by a spring disposed within housing 100. Operator 102 is adapted to enable a user to retract pin 98, if desired.

To secure arm-to-slide bracket 66 to slide bracket 64, arm-to-slide bracket 66 is aligned with slide bracket 64 so that hooks 94 of the arm-to-slide bracket 66 may be disposed through openings 92 of slide bracket 64, as represented by arrows 104 in FIG. 6. Disposing arm-to-slide bracket 66 against slide bracket 64 will compress pin 98, as illustrated in FIG. 7. In this view, arm-to-slide bracket 66 is displaced to the left relative to slide bracket 64, as represented by arrows 106, to engage hooks 94 against slide bracket 64.

When arm-to-slide bracket 66 is displaced laterally relative to slide bracket 64, slide bracket 64 is captured between hooks 94 and flat portions 108 of arm-to-slide bracket 66. In the illustrated embodiment a portion 110 of each hook 94 contacts the surface 112 of opening 92. In addition, each hook 94 is curved to facilitate engagement of hooks 94 against each surface 112 as arm-to-slide bracket 66 is moved to capture slide bracket 64.

In addition, when arm-to-slide bracket 66 is displaced laterally relative to slide bracket 64, pin 98 of plunger pin 70 is aligned with hole 96. Pin 98 is biased to extend into hole 96, as represented by arrow 114. With pin 98 disposed within hole 96, arm-to-slide bracket 66 is locked to slide bracket 64. Transverse displacement of arm-to-slide bracket 66, relative to slide bracket 64, is blocked by hooks 94 and flat portions 108. Lateral displacement of arm-to-slide bracket 66 relative to slide bracket 64 is blocked by pin 98.

If desired, cable support arm 50 may be removed from chassis bracket 60 and slide bracket 64. To remove cable support arm 50 from slide 44, pin 98 is retracted from hole 96 by applying a force to operator 102 in the direction represented by arrow 115 in FIG. 7. This enables arm-to-slide bracket 66 to be displaced laterally to the right relative to slide bracket 64 in the direction represented by arrow 116 in FIG. 7. Hooks 94 are then aligned with openings 92 in slide bracket 64 to enable the hooks 94 to be withdrawn through openings 92. Arm-to-slide bracket 66 may then be withdrawn from slide bracket 64 in the direction represented by arrow 118 in FIG. 6, thereby freeing cable support arm 50 from slide 44.

While the subject matter may be susceptible to various modifications and alternative forms, specific embodiments have been shown by way of example in the drawings and will be described in detail herein. However, it should be understood that the subject matter is not intended to be limited to the particular forms disclosed.

What is claimed is:

1. A cable support system, comprising:
a cable support arm;
a first member secured to the cable support arm, the first member being adapted to be disposed to a first position relative to a second member and to prevent transverse displacement of the first and second members when the first member is displaced laterally to a second position relative to the second member; and
a movable pin adapted to block lateral displacement of the first and second members when the first member is displaced in the second position relative to the second member.

2. The cable support system as recited in claim 1, wherein the movable pin is secured to the first member.

3. The cable support system as recited in claim 2, wherein the movable pin is biased to extend through a hole in the second member when the first member is displaced in the second position relative to the second member.

4. The cable support system as recited in claim 2, comprising the second member, wherein the second member comprises an opening adapted to receive a first portion of the first member.

5. The cable support system as recited in claim 4, wherein the opening is a keyed slot.

6. The cable support system as recited in claim 4, wherein the first member comprises:
a first portion adapted to be disposed through the opening in the second member; and
a second portion adapted to be disposed against the second member, wherein the first and second portions of the first member are adapted to capture the second member therebetween when the first member is disposed in the second position.

7. The cable support system as recited in claim 6, wherein the first member comprises a hook.

8. The cable support system as recited in claim 6, wherein the first member comprises a mushroom-shaped pin.

9. The cable support system as recited in claim 6, wherein the first portion comprises a curved surface adapted to engage a corresponding surface of the opening in the second member as the first member is disposed laterally to the first position relative to the second member.

10. The cable support system as recited in claim 1, wherein the cable support arm comprises a first arm member coupled to a second arm member by a hinge.

11. The cable support system as recited in claim 10, wherein the first member is coupled to the first arm member by a second hinge.

12. The cable support system as recited in claim 10, comprising a plurality of straps adapted to secure a plurality of cables to the first and second arm members.

13. A system, comprising:
a movable electrical device;
a first member securable to one of the movable electrical device and a fixed member; and
an articulated arm securable to the first member, the articulated arm comprising:
a second member adapted to hook the first member; and
a movable pin adapted to selectively maintain the second member hooked to the first member.

14. The system as recited in claim 13, wherein the movable pin is secured to the second member and the first member has a hole therethrough, the movable pin being biased to extend outward into the hole in the first member.

15. The system as recited in claim 14, wherein the movable pin is adapted to be retracted from the hole.

16. The system as recited in claim 13, comprising:
a third member securable to one of the movable device and the fixed member, the third member having a hole therethrough;
a fourth member secured to the articulated arm and adapted to hook the third member; and
a second movable pin adapted to extend maintain the fourth member hooked to the third member to secure the cable support arm to the third member.

17. The system as recited in claim 16, wherein the first member is securable to the movable device and the third member is securable to the fixed member.

18. The system as recited in claim 13, wherein the second member is secured to the articulated arm by a hinge.

19. The system as recited in claim 13, wherein the movable electrical device comprises a server.

20. A method of installing an electrical device within a storage rack, comprising:
disposing a first portion of a cable support arm against a first bracket secured to an electrical device; and
displacing the first portion of the cable support arm laterally in relation to the first bracket to lock the first portion of the cable support arm to the first bracket.

21. The method as recited in claim 20, comprising securing a first bracket to the electrical device.

22. The method as recited in claim 21, comprising:
securing a second bracket to the storage rack;
disposing a second portion of the cable support arm against the second bracket; and
displacing the second portion of the cable support arm laterally in relation to the second bracket to lock the second portion of the cable support arm to the second bracket.

23. The method as recited in claim 20, wherein disposing comprises inserting a plurality of hooks through a plurality of openings in the first bracket.

24. The method as recited in claim 23, wherein displacing comprises sliding the first portion along the first bracket to enable the plurality of hooks to engage the first bracket.

25. The method as recited in claim 20, wherein displacing comprises aligning a biased pin disposed on the first portion of the cable support arm with a hole in the first bracket.

26. An electrical system, comprising:
means for securing a first bracket to one of a movable device and a fixed member; and
means for locking a first portion of a cable support arm to the first bracket without use of a tool.

27. The system as recited in claim 26, wherein the means for locking comprises a movable pin biased to extend through the first portion of the cable support arm and the first bracket.

28. The system as recited in claim 26, wherein the means for securing comprises a threaded fastener.
